(19) United States
(12) Patent Application Publication
(10) Pub. No.: US 2017/0103650 A1
(43) Pub. Date: Apr. 13, 2017

(54) SIGNALLING SYSTEM FOR REGULATING ROAD TRAFFIC

(71) Applicant: Alexis AMADON, Villiers-saint-Frédéric (FR)

(72) Inventor: Alexis AMADON, Villiers-saint-Frédéric (FR)

(21) Appl. No.: 15/317,413

(22) PCT Filed: Jun. 23, 2015
(86) PCT No.: PCT/IB2015/054708

§ 371 Date: Dec. 9, 2016

(30) Foreign Application Priority Data
Jun. 24, 2014 (FR) 1401417

(51) Int. Cl. G08G 1/095; G08G 1/005

(52) U.S. Cl. CPC G08G 1/095; G08G 1/005

(57) ABSTRACT

The invention is intended to replace three-colour traffic lights or STOP signs in order to enable motorists to benefit from an alternation of right of way at intersections, without any prolonged or superfluous waiting times in the cases where concurrent lanes are either congested or free of vehicles. The invention comprises an illuminated signal (3) controlled by a traffic light controller and representing a STOP or give-way sign post in force in the highway code. The illuminated signal remains lit for as long as the lights of concurrent lanes, where applicable, are green (1), yellow (2), or for as long as the STOP/give-way signals of concurrent lanes are off, where applicable. It is advantageous to combine three-colour traffic lights with the signal (3) on the same sign post so as to render the right of way explicit.

### 1. BACKGROUND OF THE INVENTION

The technical domain of the invention is road traffic control by means of signalization Around the world, the highway code is ruled by a signalization which tends to become universal. In Europe, a Convention on road signalization was signed in 1968, later amended with technological evolutions before being consolidated in 2006 in the UNECE document, “Convention on Road Signs and Signals of 1968 European Agreement Supplementing the Convention and Protocol on Road Markings, Additional to the European Agreement (December 2006)”, under the reference ECE/TRANS/196. In this official document the tricolor traffic lights are described as well as the “STOP” and “Yield” (or “give way”) road signs. Also, for instance, in France, the use and conformity of traffic lights and “STOP” and “Yield” signs is dictated by the Inter-ministry Instruction on Road Signalization, so-called IISR, regularly modified by new rules taking into account new European norms or new technologies. The advantageous object of the invention described hereby, so-called “alternating stop sign” or “yield light” later in this document, is a combined new use of known means which have, until now, always been exploited independently from one-another. This combined new use of known means allows to efficiently solve a problem which has been experienced for a long time without ever being completely addressed. Indeed until now, as a temptation to reduce dead time at traffic lights, public authorities have selected solutions based on vehicle-detection sensors at certain crossings equipped with traffic lights. Not withstanding the fact that sensor installation and maintenance costs are expensive and require data feedback towards the traffic light controller which must continuously adapt green and red light signal durations depending on traffic, these solutions are only partly efficient because significant dead times remain in practice. On the other hand, the present invention offers a simple, efficient and smart alternative to tricolor traffic lights at crossings where visibility is sufficient to allow any driver to engage across the intersection if he/she judges that no vehicle threatens to go across his/her way, as he does in front of a traditional stop sign. This combined new use of a signaling system is truly innovating because it authorizes in a simple and efficient manner the smart alternate sequence of traditional traffic lights with the usual stop or yield sign. Thus, on one hand, in case of heavy traffic, the yield light acts in the same way as traditional traffic lights, each road across the intersection being granted the right of way for a given amount of time, one after the other; drivers then have to wait for their traffic sign to turn into a green light before they can go across the intersection. On the other hand, in case of lighter traffic, the yield light exploits the STOP or Yield signal to allow drivers to go across the intersection before their green light shows up, eliminating the drawback of tricolor traffic lights.

The hereby-proposed system cleverly combines the advantages of traffic lights and stop signs, but none of their drawbacks. In front of a traditional stop sign, in case of heavy traffic, a driver may have to remain stopped for a very long time before being allowed to move on. In that case, a substitution of the stop sign by tricolor traffic lights could significantly reduce his/her waiting time. However, inversely in case of little traffic, when facing a red light, drivers must wait until their light turns green even if no vehicle comes across the intersection, which represents a waste of time for them and all other drivers waiting behind, while nobody can benefit from this time; here the STOP or yield sign could instead considerably decrease the wait. Thus in both cases, not only drivers uselessly waste time which can dramatically accumulate on a commuting journey where traditional signaling systems multiply at crossroads, but also air pollution linked to exhaust gas released by these waiting vehicles is significantly increased with respect to a situation where drivers would have the right to go as soon as their way is clear. To address this issue, the yield-light advantageously combines traffic lights and a luminous STOP or Yield sign in a dynamic sequence within a single device, without the need for a complex or costly vehicle detection system, whose effectiveness to eliminate dead time is limited. Indeed, with respect to a traditional traffic light, the duration of a red light embedded in a yield light device is shortened to a few seconds, or even nulled as will be seen in an embodiment of the invention, before display of the STOP signal, which then effectively substitutes for the red light. In the hereby request (including in what precedes this paragraph), the so-called “motorist” designates any vehicle driver subject to road traffic laws, whether the vehicle is a truck, a coach/bus, a car, a motorbike, or a 3-wheeler; the so-called “crossroads” designate any crossing of roads open to traffic and subject to signaling the right of way, whatever the number of converging ways; by extension, a so-called “intersection” designates either a crossroads or a mere pedestrian crossing on a traffic road equipped with a signaling system for pedestrian/vehicle right of way. By extension too, a “competing way” refers to any way, be it for vehicles or pedestrians, which goes across a reference road, named “A way”, for which the yield light operating sequence is described. At last, when a yellow light is evoked, it designates the light lit up before the red light in a column, row or any assembly of tricolor traffic lights, even if this light may appear orange in certain countries.

### 2. THE PRIOR ART

Below are presented technical objects and inventions associating “STOP” or “give-way” signs to traffic lights, or reporting luminous or intelligent STOP signals.

The combination of a stop sign or, more frequently, of a yield sign to tricolor traffic lights is used at some crossroads to indicate to motorists to give way in case of tricolor light failure or when the light turns to flashing yellow, for example at night when traffic is reduced. In such a situation, the right-of-way alternation claimed in the present invention is not ensured between competing ways: a single road is then assigned the right of way, as when the intersection is simply governed by a stop or yield sign. This assembly of traffic lights and sign does not solve the problem addressed by the simple, efficient and intelligent alternation mentioned above.

The association of a colored light on a STOP board is presented in the already old U.S. Pat. No. 5,755,051 patent granted in 1998, Warning Light and Sign Apparatus. Its goal is to reinforce the visibility of a portable panel for temporary use along roadworks, for instance, showing “STOP” on one side, with an associated red light, and “SLOW” on the other side, with flashing yellow light. Here again this combination does not solve the problem addressed by the invention introduced earlier.

The also old U.S. Pat. No. 6,054,932 patent granted in 2000, LED Traffic Light and Method of Manufacture and Use Thereof features a matrix of Light Emitting Diodes (LED) able to display either a red light, a yellow light, or a green light, or yet, in an equivalent manner, the words STOP (in red)/Caution (in yellow)/GO (in green). The one and only purpose of this patent is to save material in the manufacturing of traffic lights by gathering the latter in a single casing (instead of three). For this an assembly of LEDs is used to display different signals according to the appropriate moment of the tricolor light cycle. In this way this patent may comply with the Consolidated Resolution on Road Signs and Signals (R.E.2), revised by UNECE in 2010 under the reference ECE/TRANS/212, whereby a section describes “special light signals using matrix symbols”, to designate boards which may broadcast variable signals, like a speed limit changing depending on the time of the day, meteorological conditions or traffic density. But once more, that invention does not address the problem discussed in the introduction; neither do the 2002-granted U.S. Pat. No. 6,409,358 patent, Illuminated STOP Sign, or the 2001-published patent request EP1164817, Outdoor electroluminescent display devices (both patents hence rather old), which describe luminous STOP signs to increase the visibility of the message intended to make the motorists stop, in particular at night.

Ultimately, the only more recent invention which attempts, to no avail, to solve the problem addressed in the introduction by the present invention, is exposed in the US 2010/0283631 patent request, Smart STOP Sign (published in 2010); this intends to be an alternative to all-way STOP at intersections where STOP signs are erected on all competing ways (layout very much in use in the USA). This invention requires solar panels, a manual control system, and an expensive vehicle detection system like electromagnetic loops placed in the roadway. None of these elements is required in the novel invention presented hereby, which is significantly and advantageously much more simple and economical. Moreover, in that US 2010/0283631 request, the tricolor traffic light signaling known by motorists in the entire world is not explicitly used, but only counterfeited in an ambiguous way by the lighting of a rectangular green part at the center of a STOP sign, and of trapezoidal red parts at its top and bottom parts, following a STOP & GO cycle relying on the order of vehicle arrivals at the intersection. Apart from the fact that this signalization does not exist in any highway code, the exposed alternating right-of-way system is complicated and may prove very inefficient in practice in case of heavy traffic. Its inventor confessedly alleges it is intended for intersections where traffic is light. Conversely, the hereby-exposed invention does not have this limitation and fits all traffic situations, while its fundamental goal is to get rid of dead time imposed by traditional traffic lights, and, in this way, significantly reduce the air pollution generated by uselessly waiting vehicles.

Contrary to what has just been exposed related to the prior art, the purpose of the present invention is to bring a simple, efficient and smart solution to an objective technical problem always encountered until now, which is, independently from circumstances, how to reduce waiting time imposed by “STOP” or “yield” signals, and how to get rid of dead time imposed by traditional traffic lights. In an explicit manner, the hereby-disclosed solution to the above objective technical problem consists in automatically giving and managing optimal visual indications on right-of-way conditions of the said intersections while reducing waiting time and removing dead time, whatever the circumstances, by means of programmable traffic light controllers known from the prior art.

For this matter, next are summarized some standards related to traditional permanent programmable traffic light controllers which can advantageously be used to drive the object of the invention. In France, in 2014, these norms are described in the following documents:
1. NF EN 12675 (December 2000)—Road Traffic Signal Controllers—Functional Safety Requirements.
2. NFC 70-238 (HD 638) (August 2001)—Road Traffic Signal Systems.
3. NF P 99-100—Signalized Intersection Controllers—Common Practice for Functional Safety.
4. NF P 99-022-1—Signalized Intersection Controllers—Methods for Controller Testing.
5. NF P 99-105 (May 1991)—Road Traffic Management—Signalized Intersection Controllers—Functional Characteristics.
6. NF P 99-110 (June 1990)—Road Traffic Management—Signalized Intersection Controllers—Data Exchange by wire links to external organs—Functional Characteristics and Connection Definitions.

Programmable traffic light controllers that are currently available on the French market are all based on microprocessors and are therefore compatible with the present invention. Their non-exhaustive list is the following:
1. Garbarini trademark (FARECO company), Gallery model
2. Lacroix Trafic trademark, Traffy3 model
3. Polyvelec trademark, Azur model
4. Aximum trademark, M@estro 8, M@estro 16, M@estro 32, and Castor models
5. SEA Signalisation trademark, CLP 7700 model.

### 3. DESCRIPTION OF THE INVENTION

The goal of the present invention is to offer an efficient solution to the problems and drawbacks of the devices and systems of the prior art presented above. It thus aims at very significantly reduce the waiting time imposed to motorists by “STOP” and “Yield” signs, and remove dead time imposed by traditional tricolor traffic lights.

According to the present invention, a new road traffic management is proposed based on a signaling system arranged at a crossroads or at a mere pedestrian crossing, either one named “intersection” in the following, said signaling system being composed of a programmable controller driving a set of luminous signals arranged above or beside the road near the intersection, said traffic management being remarkable in that there are typically four types of said signals whose temporal sequence follows:
1. green or flashing yellow light,
2. yellow light,
3. red light, whose duration is typically of a second or so if the intersection is simple, that is to say with only two competing ways,
4. STOP or Yield signal, bearing their respective meaning from the highway code, to effectively assign road users an alternating right of way with no dead time at the said intersection.

Thus the object of the present method is a new combined use of known means which, so far, have always been used independently from one another. This new combined use of known means allows to respond efficiently to a need felt for a long time without ever being truly filled. Indeed, as reported earlier, the present invention offers a simple, efficient and smart alternative to tricolor lights at traffic intersections where visibility is sufficient to allow motorists to engage into the intersection if no vehicle threatens to cross their path. This new combined use of a signaling system is genuinely innovative because it empowers in a simple and efficient manner the smart alternation between the operation of tricolor traffic lights and the usual function of STOP or Yield signs. Thus, in case of dense traffic, the yield light allows traffic control in a traditional manner, as tricolor traffic lights would, each lane coming to the intersection being assigned the right of way in turn, for a given amount of time. However, in case the way is clear, the yield light automatically authorizes the motorist not to wait that his traffic light turns green to go across the intersection, thanks to the meaning of the STOP or Yield sign in the highway code, which eliminates the tricolor traffic light drawback.

In this way, the present traffic management method advantageously exploits the combination of means known from the prior art but used hereto for a new purpose, causing a novel effect, remarkable in that it has been desired for a long time but has never been achieved so far. This novel effect is genuinely remarkable because the cleverly combined means hereto have been well known and used daily for a large number of years, proof of which being the old dates of all the documents of the prior art that relate to the domain of the invention. The features of that combination allow to mutually reinforce their effects, in such a way that a new technical result is achieved via clear visual indications, automatically and instantaneously usable by motorists. The way to address the technical problem and the right combination of known means have also significantly contributed to the desired result and technical effect achieved. The main goal of the invention, i.e. reducing the waste of time and getting rid of dead time usually imposed by traditional tricolor traffic lights, is completely reached, which allows, moreover, to advantageously and significantly reduce air pollution generated by vehicles which, otherwise, remain uselessly in line with their engines running

In the general approach, the inventive system discussed here is, in principle, the sequential combination of traffic lights with a luminous STOP sign (or any luminous signal meaning to give way), which lights up either instead of the red light (which is not essential any more), or immediately after the red light (typically one or two seconds thereafter for a simple intersection). In the first case, the yield light sequence comes with three consecutive states (green-yellow-STOP); in the second case, it comes with four consecutive states (green-yellow-red-STOP). This device is compatible with the current highway code in that it uses already existing signaling elements, and combines them cleverly to improve traffic flow at crossroads, whatever the traffic density. This device can only be used at intersections where visibility is good and unobstructed, so as to allow the motorist to safely assess whether his way is clear.

Like a tricolor traffic light, the yield light can a priori be equipped with an assembly of a green light, a yellow light, and an intermittently luminous STOP or Yield signal, but it is not necessarily limited to this assembly as will be seen in several variations next. Let a yield light be on way A in front of an intersection. A three-state cycle is foreseen by default, each state duration being programmable via a traditional traffic light controller: first the A-way light is green and gives the right of way to motorists coming in front of this light, then it becomes yellow to warn about the imminence of the mandatory stop for the vehicles coming next. In a third step, the STOP signal turns on as the yellow light switches off, to force the motorist to stop and give way to any vehicle arriving at the intersection. Optionally, this third period can be preceded by a transitional red light, for a second or so, in order to save the integrity of the tricolor light known by all motorists around the world. Once the red light is off and the STOP sign is on, if the way is clear, i.e. if no vehicle shows up approaching from competing lanes, the motorist on way A may drive forward with no waste of time facing a vehicle-free intersection. After him/her, other vehicles may then arrive at the intersection, stop, and go if the way is still clear, until the STOP sign turns off as the corresponding green light switches on. The vehicles on way A can then move on freely because their path is protected. The right of way cycle is thus completed. As for traffic lights, opposing signals are displayed to pedestrians and motorists coming from competing ways, i.e. pedestrian gateways or road lanes crossing the A way: while the green or yellow light is shown on way A, a red light or a STOP signal remains lit up on each of the competing lanes, and vice-versa. In the following, the example of a simple crossroads is shown with yield lights installed at each of the four intersection corners, the three-state cycle of these yield lights is then presented. This scheme can be generalized not only to more complicated crossroads, but also to pedestrian crossings, whether these are located at a road intersection or isolated in the middle of a road equipped with a yield light: the light is then green or yellow only for a traffic way whereas competing ways have STOP signs, or else red lights.

For the management of the alternating right-of-way, the system to implement the invention must contain a programmable traffic light controller which synchronizes lights and STOP signals in the same way it would synchronize traditional traffic lights Thanks to the controller, it is in particular possible to add a small delay between the time a luminous STOP turns on and when the light of a competing way turns green. Without the red light option introduced earlier, the yield light controller may be identical to the controller used for tricolor traffic lights, since the STOP signal control is strictly equivalent to the red light control of traditional traffic lights. Then this controller does not have any novel feature by itself. However, if the red light option is integrated, an additional control is required to automatically turn that light on just before the STOP signal ignition: the yield light cycle then goes from three states (green-yellow-STOP) to four states (green-yellow-red-STOP).

In either form of the invention discussed next, the luminous STOP sign can advantageously be topped by a sun visor, in the same way as the green and yellow lights might be. This allows the yield light to be more visible in case of strong sunlight. Moreover the visor can protect the yield light and its electronic components from rainfall, snow and hail

The following elements are part of the implementation device of the invention since they are necessary to its sustainable operation: the traffic light controller, the luminous sign and traffic light support, such as brackets, lateral posts, or yet cables from which lights and signs may be hung, road markings described later, and pedestrian sign lights. These elements not being novel, they have been omitted from the drawings for the purpose of clarity.

### 4. VARIOUS EMBODIMENTS OF THE INVENTION (DESCRIPTION OF THE DRAWINGS)

Other advantages and features will come out of the following description of preferred embodiments of the signaling system used in the hereby-presented method, referring to the joined figures given as non-limiting examples of implementations.

On joined figures, Arabic numerals designate constituents of various forms of yield light. Roman numerals designate successive states in the operating cycle of a yield light. Letters identify sub-figures within a figure. Constituents of yield lights presented on the figures are:

1: green light in its waterproof housing, with either an incandescent light source or based on LEDs, topped by an optional sun visor, desirable if the light is detached from the STOP sign.

1′: LED-based version of the green light described in 1, being entirely part of the luminous STOP board. The LEDs composing this light can light up with at least two different colors depending on the intended control, one of these colors being green, the other one being red or white depending on the light position on the STOP board and on the LED location in the light.

2: yellow light in its waterproof housing, with either an incandescent light source or based on LEDs, topped by an optional sun visor, desirable if the light is detached from the STOP sign.

2′: LED-based version of the yellow light described in 2, being entirely part of the luminous STOP board. The LEDs composing this light can light up with at least two different colors depending on the intended control, one of these colors being yellow, the other one being red or white depending on the light position on the STOP board and on the LED location in the light.

2″: flashing version of the yellow light described in 2 or 2′. The strokes around the disk symbolize the flashing nature of the light.

3: luminous STOP sign in its waterproof housing, with either an incandescent light source or based on LEDs, topped by an optional sun visor, and switched by a traffic light controller as a traditional red light would be.

3′: small version of the luminous STOP sign described in 3, allowing its integration in a column (or row) of traditional traffic lights, typically above (or to the right of) the red light, or even instead of the red light.

3″: LED-based version of the luminous STOP sign described in 3, allowing the integration of one or more traffic lights therein. The LEDs constituting the said lights are part of the LEDs constituting the luminous STOP sign. They can be red (cf. example in FIG. 4), bi-colored, three-colored, or even four-colored depending on their location and the luminous STOP sign model (cf. FIG. 6).

4: red light in its water-proof housing, with its incandescent light or LED-based source, topped by an optional sun visor, desirable if the light is detached from the STOP sign.

4′: red light integrated in a yield light board, composed of LEDs that can be bi-colored, three-colored, or four-colored, depending on their location and the model of the yield light board (cf. FIG. 6).

5: luminous “Give way” or “Yield” sign in its waterproof housing, with its incandescent light or LED based source, topped by an optional sun visor and whose onset is controlled by a traffic light controller as done for a traditional red light.

5″: LED-based version of the luminous Yield sign described in 5, allowing the integration of one or more traffic lights therein. The LEDs constituting the said lights are part of the LEDs constituting the luminous Yield sign. They can be red, bi-colored, three-colored, or even four-colored depending on their location and the model of the luminous Yield sign (cf. example in FIG. 13).

6: small circle representing one LED amongst the LED matrix covering the yield light board. Depending on its location on the board, each LED is linked to a set of controls defining its state (off or on with one color).

FIG. 1 shows a schematic view of a three-state yield light, according to a first embodiment of the invention. First the light is green (1), informing motorists they can drive forward, then it turns yellow (2), warning them of the imminence of the STOP sign onset (3). In this first embodiment, the device looks like a tricolor traffic light where the red light has simply been replaced by a luminous STOP signal whose triggering occurs instead of the red light. In this embodiment, the yield light has three possible states: green, yellow, or STOP. The red light absence allows a total compatibility of the yield light with existing traffic light controllers since these need not be reprogrammed: the STOP signal on/off control is then the same as that for a traditional red light.

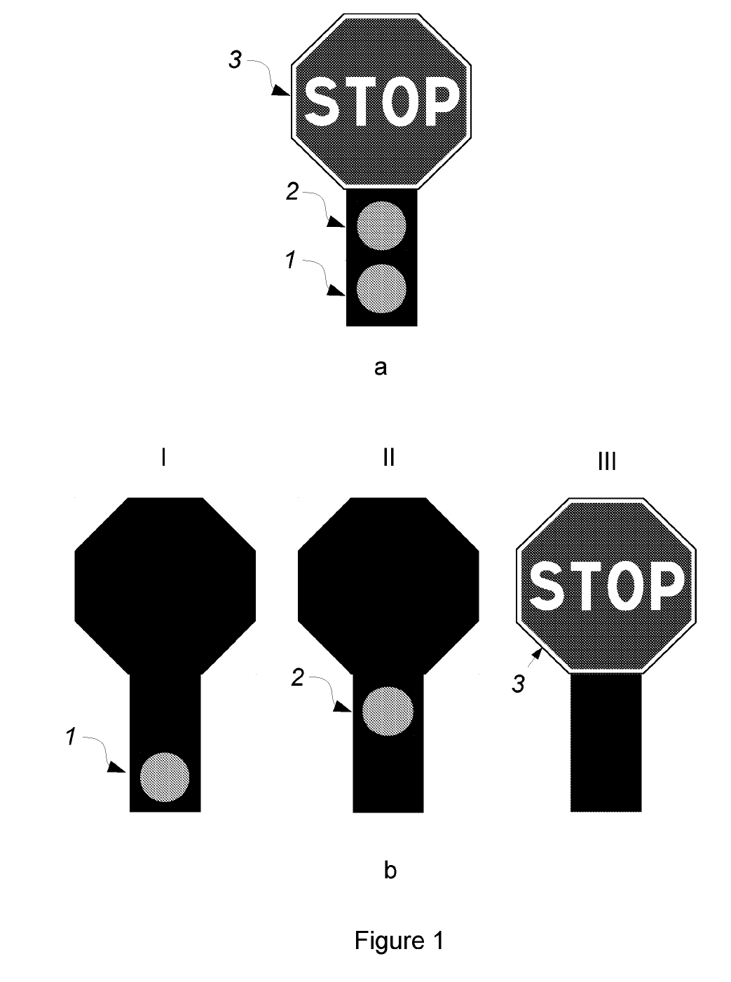

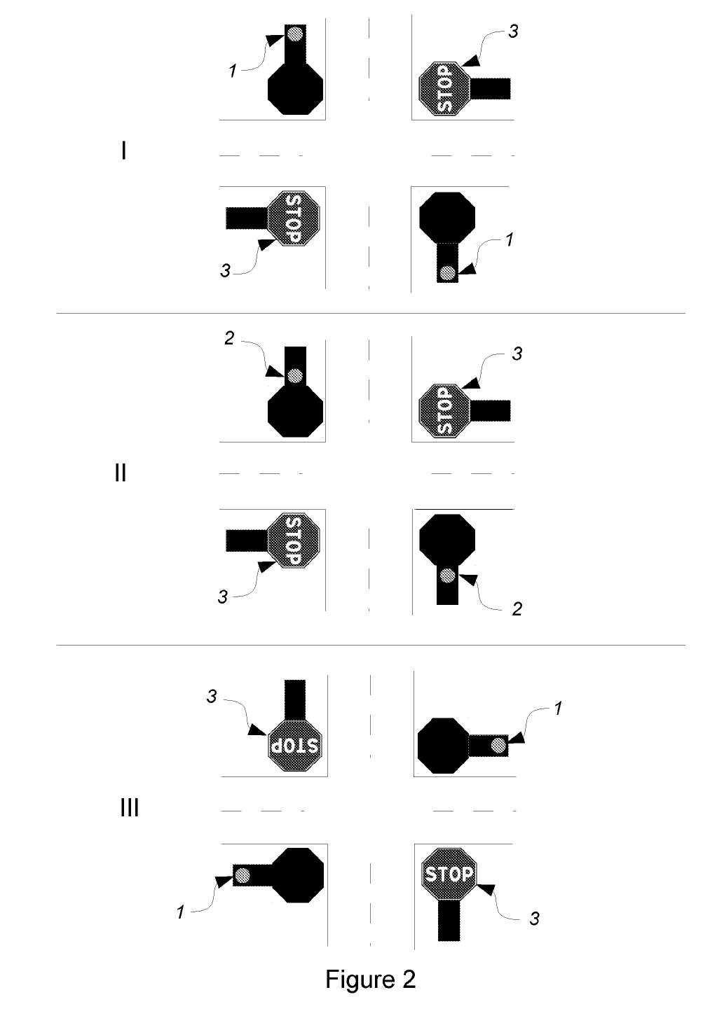

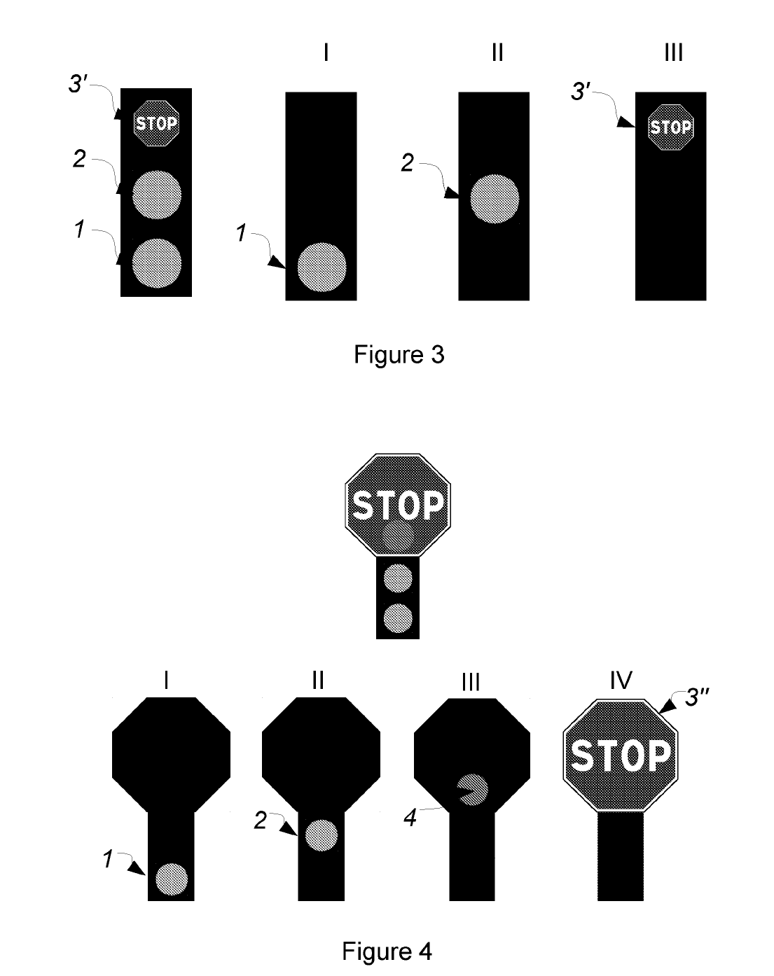

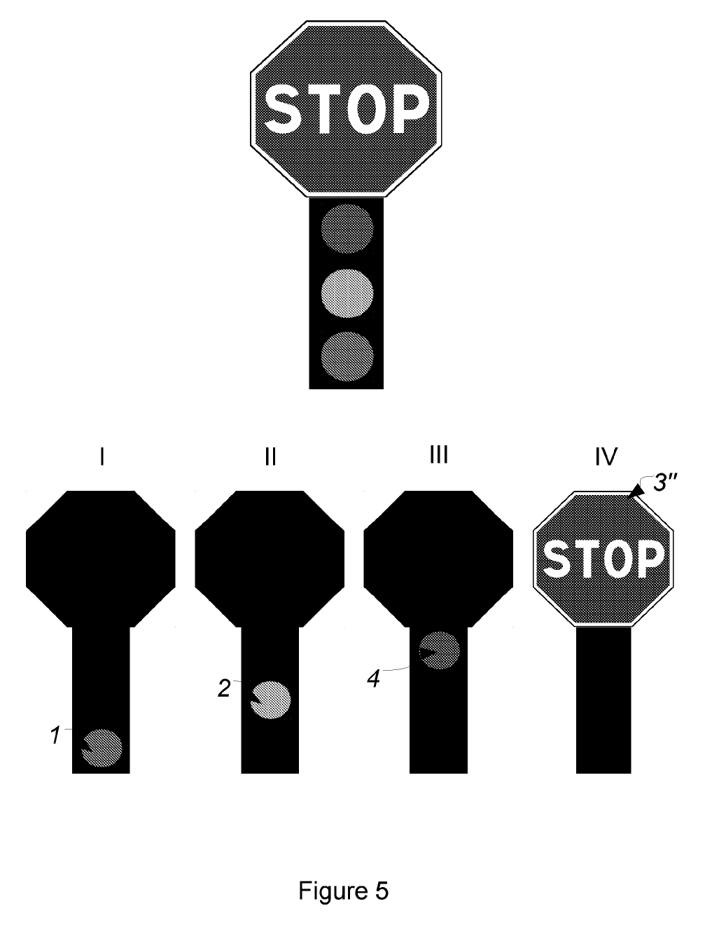

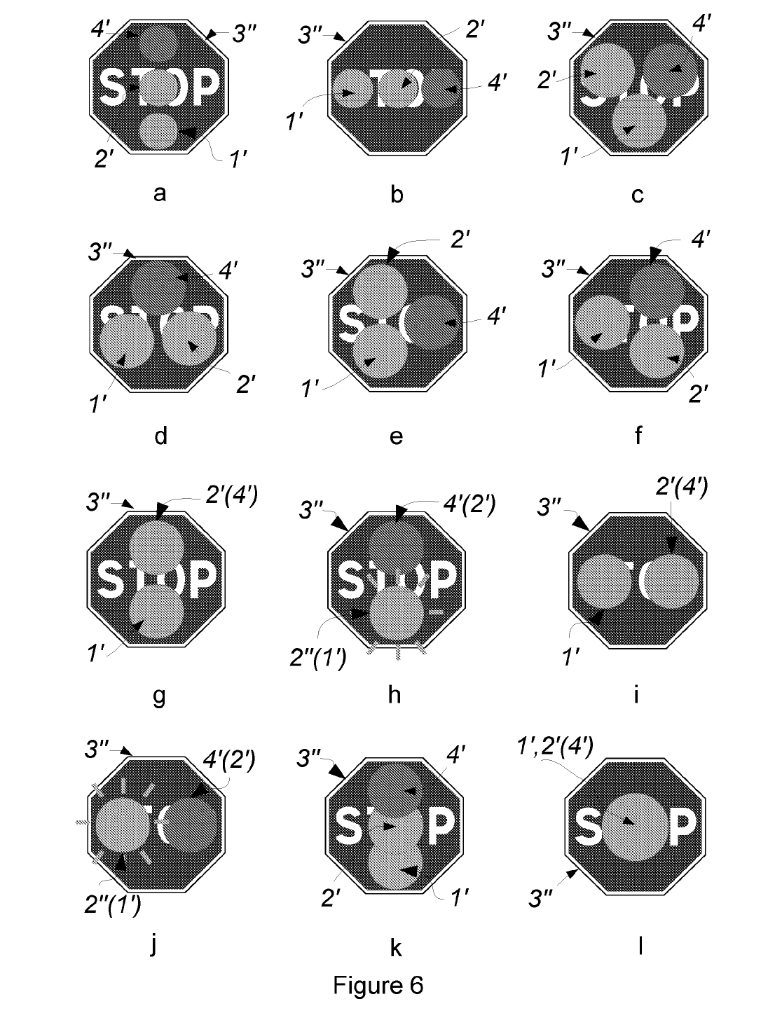

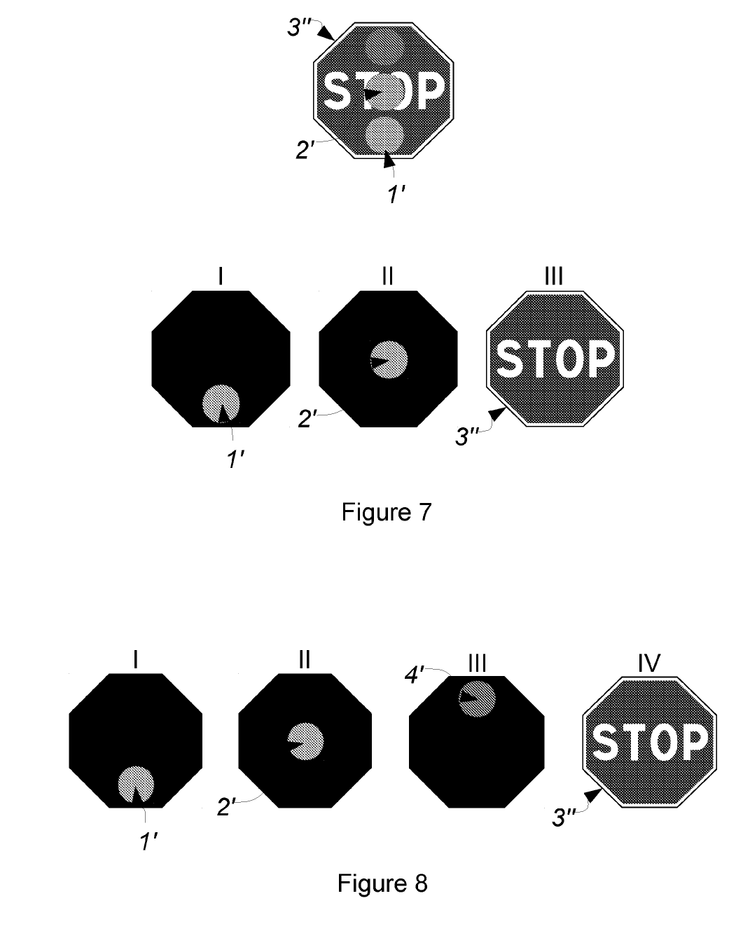

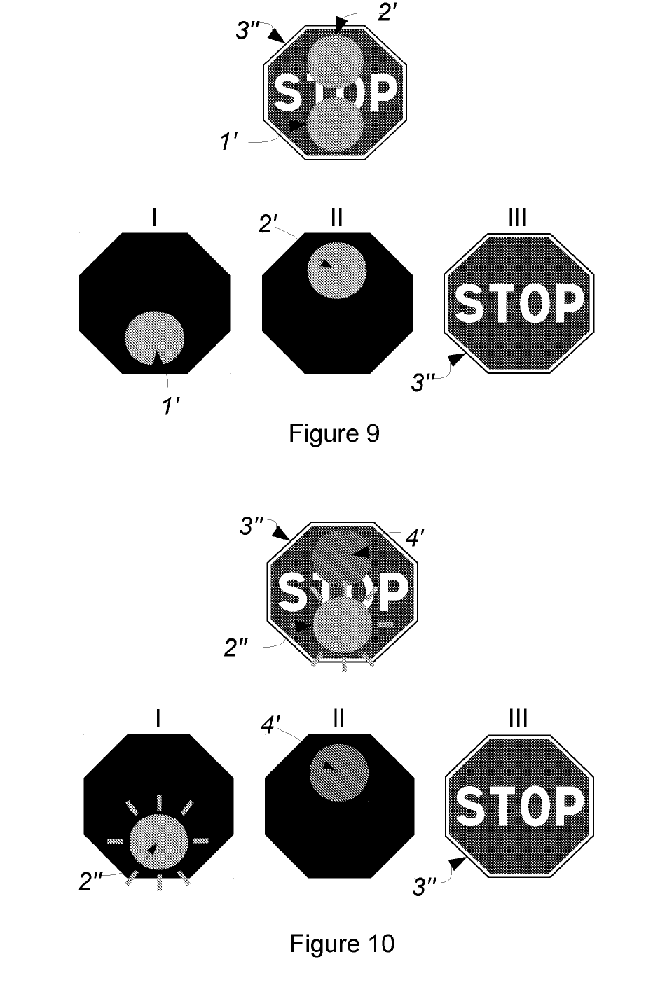

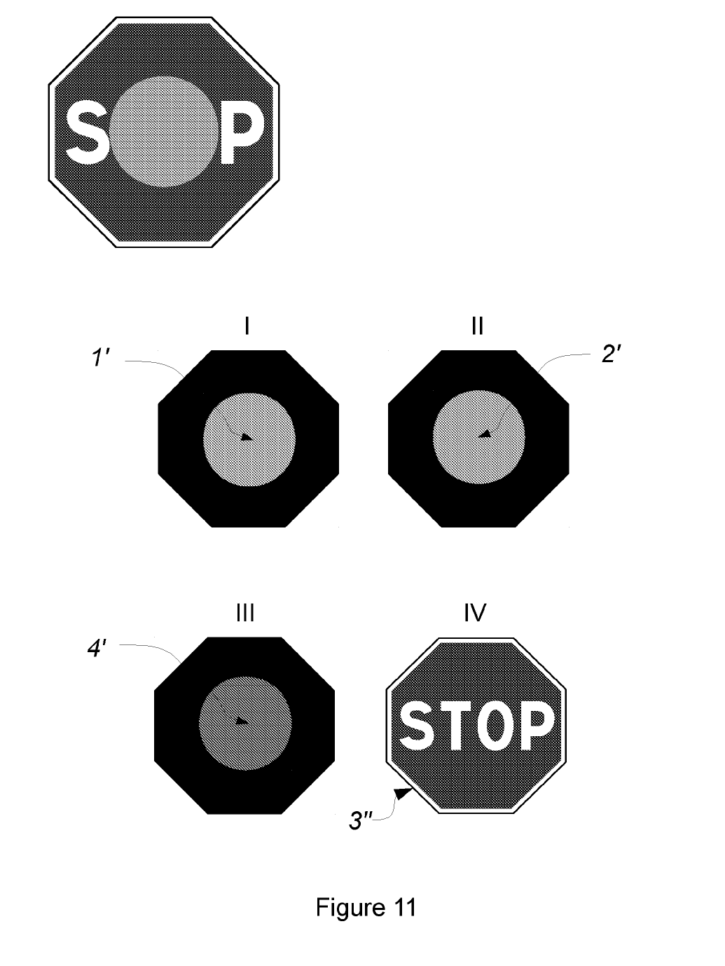

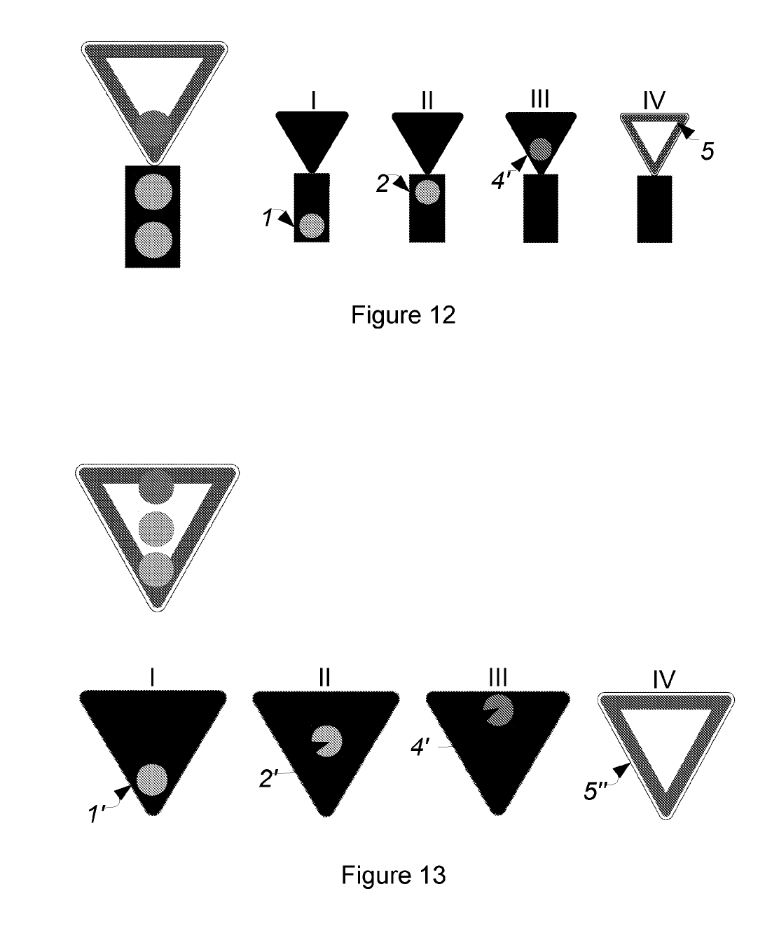

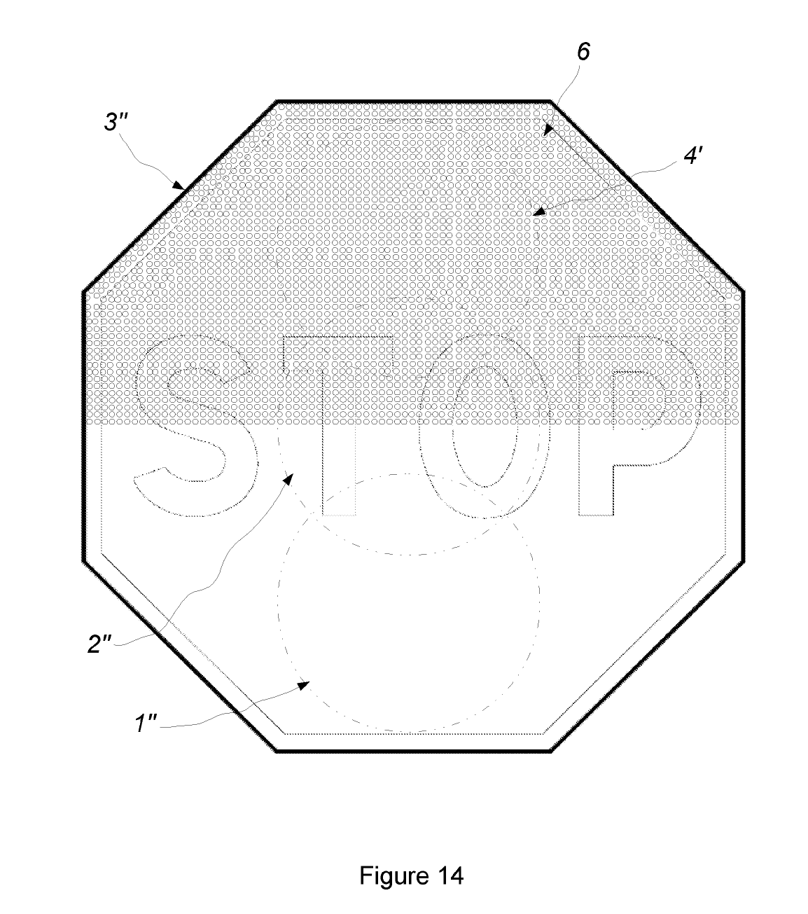

In this example, the relative size of the STOP sign with respect to the green and yellow lights may vary depending on local rules or the type of roads on which this device is installed. However, as shown in FIG. 1, the luminous STOP sign has typically a larger size than its associated lights, as traditional STOP signs do with respect to each of the three traditional traffic lights. In the example in FIG. 1, it is to be noticed that the STOP signal tops the green and yellow lights. In another instance of this column-wise yield light form, as shown in FIG. 3, the octagonal luminous STOP signal dimension is close to that of the green and yellow lights it tops, the octagon width is then similar to the diameter of the red light disk it replaces.

Whatever its size, the luminous STOP signal is a priori the same as the one described in the highway code, that is to say the STOP word written in white on a red background inside an octagonal white frame. Two implementations exist for such a signal The first one is a low-energy white and red LED matrix with fine-enough granularity to allow for a nice visibility of the STOP word from tens of meters away, without any ambiguity. The second implementation consists in an incandescent backlight illuminating a translucent circular or octagonal window depicting the STOP signal The use of LEDs is favored because it is more cost-effective than the incandescent backlight. However, to limit even more electric consumption, dynamic signage regulation authorities recommend the use of “inverse video”, whereby a black background is used instead of white backgrounds to reduce the number of working LEDs (cf. IISR, 9th part). If such rules must apply to the yield light, an alternative form of the luminous STOP sign could then be depicted by the STOP word in white or red on a black background with an octagonal white or red frame.

FIG. 2 features the sequence of states of four three-state yield lights in the setting of two roads crossing with single opposing lanes. First the light is green (1) for the lanes represented vertically on the drawing, while the STOP sign is lit up for the “horizontal” lanes, so that the right of way is clearly given to the “vertical” lanes. Then the light on vertical lanes turns yellow (2), warning the corresponding motorists of the imminent onset of the associated STOP sign. At last, once the STOP signs are lit on the vertical lanes, the STOP signs on the horizontal lanes switch off as their associated green lights turn on (3). It is to be noticed that depending on local legislation, the 3rd state at the bottom of FIG. 2 can be preceded by a small delay whereby all 4 STOP signs are lit up simultaneously, in particular to leave some time for the vehicles already entered in the intersection to clear the crossing before the onset of the green lights.

FIG. 3 features a three-state yield light where the luminous STOP sign is integrated in a traditional traffic light column in place of the red light. The three states represented are equivalent to those shown in FIG. 1.

Optionally, a red light can also occupy the same location as the STOP signal, allowing a four-state yield light, as explained thereafter. It is then sufficient to have bicolor LEDs (red or white) at the white locations of the STOP signal

FIG. 4 features a four-state yield light, according to yet another embodiment of the invention. First (I) the light is green, informing the motorists they may move on, then it turns to yellow (II), warning them of the imminent red light onset (III), which precedes by one or several seconds the onset of the luminous STOP signal (IV). This latter state or the two latter states typically coincide with the onset of green lights for corresponding pedestrians and for vehicles coming from a competing way. In this embodiment, the presence of the red light also potentially allows the use of traditional tricolor traffic lights at rush hour, or for an extended period if ever the use of the yield light described earlier is considered unsatisfactory by local authorities. Then reprogramming the associated traffic light controller is sufficient to get rid of the 4^{th} state of the device and lengthen the duration of the 3^{rd} state. In other words, when using traditional tricolor traffic lights, the 3^{rd} state is prolonged in lieu of the 4^{th} state. In the FIG. 4 example, the STOP sign tops the green and yellow lights, but in another embodiment of the column-wise four-state yield light, that STOP sign can be positioned above (cf. FIG. 5) or below the traditional tricolor traffic light column.

FIGS. 4 and 6 to 11 show a luminous STOP sign which can integrate one or several traffic lights. The signal board is then typically covered by a LED matrix (cf. FIG. 14). Depending on their location on that board, some of these diodes are single-colored because they only need a binary state (on or off), or at least bi-colored if 3 states are required in the green/yellow/STOP cycle; bi-colored diodes are then either green or yellow, either white or red, depending on their location on the board.

In some embodiments of the invention described later, the traffic light disks overlap partially or entirely, implying the use of tricolor LEDs, or even four-colored LEDs if 4 yield light states are required. In an implementation of the invention, multicolored LEDs as explained above may be replaced by single-colored LED clusters, as explained in the U.S. Pat. No. 6,054,932 patent; however, this embodiment is not favored because it needs more material and surface area on the luminous STOP sign board. It is to be noticed here that about the embodiments depicted in FIGS. 4 to 11, the luminous STOP sign can integrate a red light which turns on either instead of the STOP sign if local authorities decide to come back to the traditional use of tricolor traffic lights, or between the yellow light state and the STOP signal state (cf. FIG. 4, but also FIGS. 8 and 11). In the first case, any switching between the yield light use and the traditional tricolor light use may be programmed in the traffic light controller. For example, throughout the day, the tricolor light may be used during rush hour while the yield light is used when traffic becomes lighter. In the second case, the red light is used to complete the four-state sequence, i.e. green, yellow, red, before giving way to the STOP sign onset. At a simple intersection like the one in FIG. 2, the red light would only be on for a short period, typically one second. In this particular instance, the addition of the red light, if not functionally required, may be used to make the invention more acceptable by authorities, because tricolor traffic lights and the STOP signal are known by the legislation whereas just grouping the green light, yellow light and STOP signal is not.

Moreover, at a complex intersection, where for example three competing ways cross each other, the red light on way A may remain as long as the displayed signals on the 2 other ways are a green light and a STOP sign. Thus right-of-way conflicts are avoided between STOP signs of competing ways since they are not lit simultaneously. With the red light option, at complex crossroads, the legislator can therefore decide to restrict the use of the STOP sign on one way at a time while another way is shown the green light, and to block traffic on all other ways with a red light. Of course, in this case, the four-state cycle (green, yellow, prolonged red, STOP) is used on each way of the crossroads in turn.

In the embodiment where the red light is integrated in the STOP sign, depending on the location chosen for the red light, bicolored LEDs may be required (either white, either red depending on whether the STOP sign or the red light is on). However, the red light may be integrated in the red background of the STOP signal, as shown in FIG. 4, in which case bi-colored LEDs are not necessary at that location.

In the FIG. 3 example, a red light can hold the same location as the luminous STOP signal if this one is composed of a set of LEDs, part of which is bi-colored, either white or red (corresponding respectively to the STOP signal and the red light). In that case, the red light may have the same octagonal shape for simplicity. But it can also take the form of a luminous disk like the green and yellow lights; then either it is inscribed in the STOP sign octagon, or its contour circumscribes the octagon, or else it is placed between inscribed and circumscribed positions. In either one of these implementations where disk and octagon are differentiated, some LEDs at the periphery of the disk or octagon must turn on and off according to the “red light” or “STOP signal” state. FIG. 6 shows in particular different embodiments of LED-based yield lights, integrating green, yellow, or red traffic lights. Although traffic lights are represented in their “on” state as well as the STOP signal shown in the background, it is obvious that this all-on state may not be displayed to motorists. The point here is to give a schematic representation of various embodiments and not a representation in operating conditions.

FIG. 6.a represents a yield light with 3 or 4 states whereby tricolor lights are arranged in a vertical column, in accordance with the most common traffic light configuration. Here the red light is optional: it should be part of the device if local authorities wish to use a four-state yield light or traditional tricolor traffic lights. Depending on the yield light implementation, the sequence of lights is represented in FIG. 7 (3 states) or FIG. 8 (4 states).

FIG. 6.b represents a yield light with 3 or 4 states whereby tricolor lights are arranged in a horizontal row, in accordance with a widespread configuration in North America. Like for the model in FIG. 6.a, the red light is optional and the sequence of signals is the same as that presented in FIG. 7 (3 states) or FIG. 8 (4 states).

FIGS. 6.c to 6.f show four-state yield lights whereby tricolor lights are arranged in an equilateral triangle, so that they can occupy more surface area on the STOP board than in the aligned configurations of FIGS. 6.a and 6.b. They are thus visible from a further distance by motorists facing them. In these triangular configurations, STOP sign and traffic light conventional sizes may be maintained.

The FIG. 6.g yield light model has a green light in the lower half of the board and a yellow light in its upper half. The sequence of states in this configuration is shown in FIG. 9. Another mode of operation can be generated with four states if the yellow light turns into a red light before the illumination of the STOP signal This change of state between yellow and red is made possible with the use of tricolor LEDs that are successively off, yellow, red and potentially white depending on their location on the luminous STOP LED matrix.

The model in FIG. 6.h has a flashing yellow light in its lower part and a red light in its upper part. The sequence of three states in this configuration is shown in FIG. 10. Optionally a green light can replace the flashing yellow light. Another mode of operation of this configuration can be generated with four states if one of the two apparent lights (lower or upper) becomes a continuous yellow light before the red light onset. The change from a green light to a continuous yellow light in the lower part is made possible with the use of tricolor LEDs that are successively green, yellow, off, and red or white depending on their location on the luminous STOP LED matrix. The change to the continuous yellow light in the upper part also requires the use of tricolor LEDs at some locations: their state is then successively off, yellow, red and white.

Models in FIGS. 6.i and 6.j are respectively equivalent to the models in FIGS. 6.g and 6.h, the only difference being in the arrangement of the traffic lights in a horizontal row rather than in a vertical column. The model in FIG. 6.k is equivalent to the model in FIG. 6.a, the difference being in the enhanced size of the traffic lights for a better visibility by motorists coming from far away. For a conventional size of STOP sign, this difference allows to overlay traffic lights of conventional size, but this requires however to make them partially overlap. As previously seen, this is made possible by the use of tricolor LEDs at the intersections of light disks on the LED matrix. At green and yellow light intersections, tricolor LEDs to be used switch from green to yellow, then red or white depending on their location on the STOP sign. At yellow and red light intersections, only some LEDs are tricolor and switch from yellow to red, then white depending on their location on the STOP board; the other LEDs of the overlapping region need only two colors: yellow and red. An overview of specific LED locations for each color set is given in FIG. 14. The hereby invention also integrates an equivalent model (not represented here), where the tricolor traffic lights partially overlap while being arranged in a horizontal row on the STOP board.

The model in FIG. 6.l presents yet another variation of the yield light invention with 3 or 4 states (depending on whether the red light is added), whereby the traffic light disks overlap completely on the surface of the STOP board. The FIG. 6.1 example shows a light overlap in the central part of the board, but any other arbitrary location of the disk of lights on the board is also covered by the invention. In this disk where lights of different colors overlap, LEDs are tricolor or even four-colored depending on their location and the number of yield light states. For the four-state version, the sequence of states is shown in FIG. 11. In this implementation, the tricolor LEDs in the disk are successively green, yellow, and red while the four-colored LEDs are successively green, yellow, red, and white.

If necessary, a person skilled in the art will know of course how to replace the STOP sign as shown in the figures described above by a “Give way” sign. For example, FIG. 12 exhibits an embodiment of the invention according to this yield light variant with 4 states. The 4 states, similar to those of FIG. 4 with the STOP sign, are shown in sequence, whereby the luminous STOP sign has been replaced by a luminous Give way sign shaped as an equilateral triangle with a white background pointing downwards. Optionally, a luminous message like “Give way” or “Yield” in black over a white background, synchronized with the onset of the said triangle, can show in a rectangle between the yellow light and the said triangle, requiring that these two elements be placed further apart from each other by the height of the said rectangle (this rectangle is not represented in FIG. 12 nor in the next one). Similarly, the example in FIG. 13 exhibits an embodiment of the invention according to the Give way variant of the invention with 4 states, whereby the tricolor lights are integrated in the luminous Yield board, in the same way as for the STOP sign in FIG. 8. At last, FIG. 14 shows, in its upper half, the detail of the LEDs constituting the yield light model presented in FIG. 6.k, which is one of the preferred embodiments of the invention. Here an octagonal board, typical of a STOP sign, is composed of a matrix of separated LEDs symbolized by small circles. The size of the board may fluctuate depending on the grade of the road above or by which it is installed. Nevertheless, if it is 60-cm wide, in the example sketched hereby, then the LEDs are spaced by about 7.5 mm in both board plane dimensions. All LEDs are connected to the STOP signal control (4^{th} state in FIG. 8). In the STOP state, LEDs located on the first two rows from the board edge are white, and so are those whose center is contained in the STOP word letters as represented on the diagram (the sketched limit of these letters does not represent a physical component of the device). All other LEDs are lit in red in that state. Also three large circles drawn with a dotted line symbolize the limits of the tricolor light disks. Each LED whose center is located inside one of these disks must be connected to the corresponding traffic light onset; the other LEDs need then to be off upon that onset. Thus the LEDs associated with traffic lights are connected to at least two commands (STOP and associated light). LEDs in green and yellow lights are at least bicolored. Red light LEDs whose center falls in one of the STOP letters are also at least bicolored. Moreover, LEDs whose center is located inside the intersection of two disks are connected to two traffic lights, hence to at least 3 commands by including the STOP signal They are tricolor, except those at the intersection of the yellow and red lights that remain in the red background when the STOP signal is lit up, for which two colors are sufficient.

Another form of implementation whereby the green, yellow, and red lights are missing represents a simplified variant of the invention. Mere luminous STOP signals are then in an ‘on’ or ‘off’ state depending on the right of way granted at a given time at the intersection or crossroads. If the signal is off on one of the lanes at a given time, this is implicitly equivalent to a green light; then the signals on competing lanes will be on to demand motorists coming from these lanes to stop and give way. Of course such a system will also be based on alternating right of ways through an automatic yet programmable controller, typically of the same type as traditional traffic light controllers. Incidentally the non-existent yellow light can then advantageously be replaced by a flashing STOP signal, warning about the imminence of a continuously illuminated STOP sign. In that variant without traffic light, pedestrian signals usually present at crossroads may be omitted on pedestrian crossings.

In another variant of the invention implementation, it can be considered to integrate only one of the two green or yellow lights, which represents an intermediate form between the device described with FIGS. 1 to 11 and the last, simplified variant. In one of these invention embodiments, only a green light is integrated in the STOP sign, so as to signify motorists their right of way when this light is on. In the other embodiment, only the yellow light is integrated in the STOP sign; if the yellow light is flashing or off, it invites motorists to move past the intersection with caution, without stopping, whereas if it is continuously ‘on’, it warns them of the imminence of the STOP signal and invites them to stop. FIG. 6.1 can represent an example of invention embodiment with a single traffic light (even though this figure also shows an implementation with several lights, whereby different light states follow one another at the same board location).

### 5. Generalization of the Invention

### 5.1 Yield Light and Tricolor Traffic Lights may Coexist at a Single Intersection

Depending on the traffic density or speed differential between competing lanes, or depending on traffic visibility from one of the lanes or the other, local authorities may wish to introduce a yield light on either one of the intersection lanes, and keep traditional tricolor traffic lights on the other lanes. The proposed invention is therefore compatible with a mix of yield lights and tricolor lights at certain crossroads or intersections. For instance the crossing of a main national road (fast way) by a secondary road (slower way) may be forbidden by a red light as long as the light on the said national road is green; however a yield light can advantageously be used on the national road, so that motorists on this presumably busier road may move on after a small stop at the luminous STOP signal is their way is clear.

5.2 Yield Light with Directional Signaling

The yield light may possibly be combined with directional traffic lights, whether these apply to the green, yellow, red, or STOP signal itself. An arrow must then indicate the direction for which the STOP is required, in close proximity to the luminous STOP sign, or highlighted on its very board if this one is constituted by LEDs. Other signals must then be associated with other directions. If no arrow accompanies the STOP signal, the latter applies to all motorists facing it, whatever the direction they wish to take.

5.3 Yield Light with Flashing Yellow Light Instead of the Green Light

The green light in question in this document can be replaced by a flashing yellow light to foster cautiousness around the intersection: indeed the STOP signal on competing lanes does not guarantee that no vehicle will come across the intersection. For instance a motorist at the STOP sign may not see any vehicle emerging, and drive his own vehicle across the intersection while a two-wheeler may come rapidly towards it. It is thus preferable to transmit a flashing yellow signal to the two-wheeler rider and more generally to all motorists, in order to lead them to slow down, rather than to transmit a green light that they might interpret as a pledge of safety. In the end, the choice between green or flashing yellow light is to be made by the public authorities. Thus the invention includes the possibility to replace the green light by a flashing yellow light. An implementation consists in having both signals available, green or flashing yellow, within the same board, according to what has been programmed in the traffic light controller. The pick of one light or the other is made possible with the use of at least two-colored LEDs that can transmit green or yellow depending on the need. In operation, these two colors are then exclusive and correspond to similar traffic light states whereby the right of way is given to the motorist facing the yield light.

5.4 Yield Light with Multiple States

In certain countries, the usual tricolor traffic lights have not 3 states, but 4 or even 5 states. The 4^{th} state is then the onset of a short-duration yellow light during the red light, which gives notice of the imminent transition to the green light following the red light. The 5^{th} state, if it ever exists, is a flashing green light between the green and yellow lights, warning about the end of the green state. Of course these states can be integrated in the yield light. The STOP state then comes in addition to the 4 or 5 existing states, to give a yield light with 5 or 6 states, respectively. However, the efficacy of the joint yellow and red state announcing the end of the STOP signal (state which could be changed into joint yellow and STOP in the yield light framework) may be questioned since the motorist facing the illuminated STOP signal may yet proceed across the intersection if he sees that vehicles on competing lanes stop in turn because their own signal turned to yellow, red or STOP. Even if, from a technical standpoint, the addition of extra states with respect to those described in preceding sections is not a problem, it is up to local authorities to assess the relevance of their use.

5.5 “Give way” Variant Instead of STOP

This invention also provides for yet another variant whereby local authorities, wishing to improve further the traffic flow at an intersection with large visibility, can choose to replace the luminous STOP signal by a luminous “Give way” or Yield signal (cf. examples in FIGS. 12 and 13). Instead of stopping when this signal is lit, the motorist then has the right to drive across the intersection after making sure that no vehicle will come across his path. The advantage of this signaling is to avoid stop-and-go jolts. Everything that was previously explained about the luminous STOP signal then applies to the Yield signal, which remains ‘on’ as long as one of the competing lanes has a green or yellow light on. All of the embodiments described earlier may take shape with the Yield signal substituting the STOP signal The “yield light” term used in this document then names either form of the invention, with the STOP signal or with the Yield signal, since the commonly used “stop-light” term only refers to the tricolor traffic light. In the following, for convenience, the yield light or STOP signal may in fact refer to either form of signals.

In particular, an embodiment of the invention is based on at least two-colored LEDs for the Give way version of the yield light (cf. FIGS. 12 and 13), compatible with the traditional use of the tricolor traffic lights. Furthermore if, at a given intersection, one of the lanes has more traffic or is faster than its competing lanes, local authorities may choose to install a Give way light on it, and to combine it with tricolor lights and/or STOP-sign yield lights on any of the competing lanes.

### 5.6 Road Markings and Pedestrian Crossings

Crossroads equipped with tricolor traffic lights cannot usually be separated from pedestrian signals. Crossroads equipped with yield lights must take pedestrians into account in the same way, except in some rare instances, like maybe the case of the yield light with no associated traffic light. The light signals for pedestrians are then strictly the same as when they are joined to traditional traffic lights: the onset of the luminous STOP signal is then considered as that of a red light. As soon as the traffic light controller switches to that STOP signal, it triggers the corresponding green light onset for pedestrians (the green light for pedestrians may possibly be replaced by a flashing yellow signal to make pedestrians cautious). The yield light, like traditional STOP signs, must be accompanied by a white band on the ground to mark the location where vehicles should stop before they can proceed. This band is typically an extension of the sidewalk edge to allow motorists to move forward as much as possible before the intersection so as to enlarge their field of view on competing lanes. If a pedestrian crossing is to be at the intersection where the yield light stands, the latter must be located before the pedestrian crossing, although the white band on the ground is placed behind the pedestrian crossing. Thus motorists must give way to potential pedestrians before halting to a complete stop at the white band when the STOP signal is ‘on’. As for tricolor traffic lights, as long as the yield light signal is green or yellow for motorists, pedestrians have their own signal set on red so they should not cross the road at that moment. Conversely, the little pedestrian green or flashing yellow symbol turns on once the luminous STOP signal is displayed to motorists on the lanes spanned by the pedestrian crossing. In the case of the Give-way yield light, a broken white line is marked on the ground as an extension of the sidewalk edge across the intersection, as for a traditional triangular Give-way sign. If a pedestrian crossing is present before the yield line, here too it is a priori preferable to position the yield light just before the pedestrian crossing, so as to invite motorists to give way to pedestrians before they do the same to vehicles.

In other cases decided by local legislation, the lateral post supporting the yield light may be positioned just behind the pedestrian crossing, as in the case of traditional STOP or yield signs. In other instances, the yield light might even be exhibited after the intersection, above the roadway, as is the case for most traffic lights in the USA. In all cases, if the STOP signal is ‘on’, it is assumed that motorists will give way to potential pedestrians before halting to a complete stop at the white band traced on the ground and extending the sidewalk.

### 5.7 Universality of the Invention

In conclusion of what has been exposed so far, the invention is meant to be universal: the proposed signaling system is totally compatible with the highway code currently in force in the entire world (in 2014), in that it only integrates signaling elements already well known, contrary to, for example, the US patent request US 2010/0283631. Both the spatial combination of such elements (STOP or yield sign with traffic lights) and their temporal sequence are innovative and constitute the subject-matter of the invention. The latter responds to a need for a more efficient and dead-time free alternating right of way for motorists. The proposed procedure better complies to urban and modern expectations than the ones offered by tricolor traffic lights or traditional STOP signs on their own.

If ever, in the future, the highway code evolves, a person skilled in the art will know how to adapt the alternating right of way discussed hereby to make it become compatible with the new code. In particular, if the usual STOP sign in 2014 is superseded by another symbol, this other symbol will be equivalently adopted and integrated in the invention. Thus the present invention is by no means limited to the embodiments described and sketched hereby, but a person skilled in the art will know how to bring forth any variant in compliance with its spirit.

### 6. DESCRIPTION OF THE PREFERRED EMBODIMENT

For yet a better apprehension of the invention, the preferred embodiment of the invention will be described next, based on models of FIGS. 6.a and 6.k, in their four-signal version: green light (1′), yellow light (2′), red light (4′), STOP signal (3″). FIG. 14 shows the detail of the board surface of FIG. 6.k. The implementation of such models has the advantage of consuming less material than the models in FIG. 1 or 5 since the yield light is based on a single LED matrix (6) that can transmit 1, 2, or 3 colors and does not need extra detached traffic lights like those shown on FIG. 1. This implementation complies with the Consolidated Resolution on Road Signs and Signals (R.E.2), revised and consolidated by UNECE in 2010 under the reference ECE/TRANS/212, whereby the “special light signals using matrix symbols” are officially accepted on road signs. The signpost described hereby is advantageously topped by a sun visor along its entire width (not represented on the figures). It integrates tricolor traffic lights and the octagonal-shaped STOP signal (3″) which motorists are used to. The four signals thus available are displayed one after the other according to the signaling state activated by the traffic light controller associated with the device; their sequence is shown in FIG. 8. The state constituted by the red light (4′) before the STOP signal onset (3″) (state number III on FIG. 8) is optional, and its existence is to be decided by local authorities. However the possibility of a red light activation is desirable because, regardless of the fact that it is useful in case of a complex crossroads as previously seen, it also allows to transform the yield light into a traditional tricolor traffic light by simple reprogramming of the traffic light controller: the state IV in FIG. 8 is then concealed. In this way, the system flexibility is enhanced, whereby the yield light may change into a traditional traffic light depending on peak hours or the discretion of the authorities. The extra cost induced by the inclusion of a red light with its control in the device is negligible because such an inclusion hardly requires any additional material.

The LED matrix (6) in the preferred invention embodiment covers the entire octagonal surface. Only part of the LEDs, those contributing to traffic light signals, are bicolored or tricolored LEDs supporting several states. In the same way as a state-of-the-art traditional traffic light, the octagonal matrix is protected from bad weather conditions in a waterproof casing, and the LEDs (6) are easily replaceable in case of malfunction. A transparent window closes the casing at the front, facing the upcoming vehicles, so that the displayed luminous signals are seen from a distance as remote as possible.

Incidentally, it is important that the sizes of the octagonal sign and of the traffic lights therein be large enough for good visibility. The diameter of conventional traffic lights is of the order of 20 to 30 cm if they are at least two meters above ground level. In some instances, the red light is larger than the associated green and yellow lights: typically, the diameter of the red light is then 30 cm whereas that of green and yellow lights is 20 cm. Yet the typical width and height of a traditional octagonal STOP sign is 60 cm, more rarely 80 cm. If ever the yield light model in FIG. 6.a is adopted to encompass a column of 30-cm lights, the size of the luminous STOP sign should be at least 90 cm high, a priori. If such a sign has the advantage of being more visible than the average traditional STOP signs, its drawback is that it is made of more material than if it remained confined in the standard size (60 or at most 80 cm), so it is heavier and has an increased wind surface area. All these factors generate a non-negligible extra cost not only affecting the luminous sign, but also the supporting post, bracket or cables. This is why the yield light model in FIG. 6.k is proposed: by enabling partial overlapping of the traffic lights via the use of tricolor LEDs in their intersections, the column of 20- to 30-cm traffic lights can now easily hold in a 60- to 80-cm-high octagon. In this way, conventional sizes of both STOP sign and traffic lights can be kept, ensuring good visibility while limiting the cost of the yield light. Furthermore, contrary to the model in FIG. 6.1 whereby traffic lights completely overlap, maintaining a column of distinct albeit partially overlapping lights allows color-blind people to differentiate the four yield light states (including green at the bottom, yellow in the center, red at the top). The model in FIG. 6.k is therefore more universal than that in FIG. 6.l. The details for the colors and locations of the LEDs composing this preferred model are given in the description of FIGS. 6.k and 14 above. In the end, each LED in the model of FIG. 14 enters one of the following categories depending on its location on the sign board. By default, the LED is off except in the states mentioned in its category:
1. red LED only ‘on’ in the STOP state (now called “at STOP”),
2. white LED only ‘on’ at STOP (3″),
3. red LED ‘on’ at STOP (3″) and at red light (4′),
4. yellow or red LED ‘on’ at yellow light (2′) or at STOP (3″) respectively,
5. yellow or white LED ‘on’ at yellow light (2′) or at STOP (3″) respectively,
6. yellow or red LED ‘on’ respectively at yellow light (2′) on the one hand, at red light (4′) and STOP (3″) on the other hand,
7. yellow, red or white LED ‘on’ respectively at yellow light (2′), red light (4′), and at STOP (3″),
8. green or red LED ‘on’ respectively at green light (1′) and at STOP (3″),
9. green, yellow, or red LED ‘on’ respectively at green light (1′), yellow light (2′), and at STOP (3″),
10. green, yellow, or white LED ‘on’ respectively at green light (1′), yellow light (2′), and at STOP (3″).

In addition to the central position, the invention covers all possible locations of the traffic light column (or row) on the sign board, as well as all possible fractions of overlap between the light disks. In particular, the case where the size of the red light (4′) is greater than those of the two other lights is taken into account: then only two out of the three light disks may partially overlap, the third one being detached from the two others. For example, if a distance is kept equal between the centers of neighboring disks, say 20 cm, whereas the diameter of the red disk (4′) is 30 cm and that of the other disks is 20 cm, then only the yellow (2′) and red (4′) light disks will partially overlap. On the other hand, the legislators may favor the large red light detachment for more visibility, in which case green (1′) and yellow (2′) lights may end up partially overlapping, even if they are smaller.

The spatial resolution of traffic lights and of the STOP signal appearing in white on a red background is determined by the surface density of the LEDs (6) on the board. This can vary from one implementation to the other, but for an 80-cm octagonal board size, LEDs could be spaced out by 1 cm in either orthogonal direction on the board plane. Any higher surface density is acceptable although it can significantly increase the cost of the yield light and of its maintenance.

The luminous STOP sign with its 3 lights, as such described, constitutes the original part of the invention. Nevertheless, to be more complete in the description of the invention device, the latter should be associated with elements allowing the yield light to fulfill its function. First the luminous board must be maintained at a certain height above the sidewalk, roadside, or roadway: this supporting function is ensured by a lateral post, a bracket, or even load carrier cables stretched above the roadway. Potentially, as is usual in the USA for tricolor traffic lights, the suspension of the sign post by a bracket or carrier cable can occur on the other side of the intersection with respect to the vehicle approaching and facing the yield light. In all cases, power supply lines for the LED matrix are routed along the support up to the sign board in a way as concealed as possible. Control cables may also be joined in a bundle to the board, but wireless control can also be enabled by electromagnetic waves transmitted by the traffic light controller. In this latter case, an antenna and a receiver must equip the luminous yield light board; the receiver then dispatches the transmitted onsets to the appropriate LEDs. The yield light controller is similar in every respect to traditional traffic light controllers. However its programming differs as it may handle 4 states per line of yield lights instead of 3 usually assumed for tricolor traffic lights, in the case where authorities have retained the red light transition between the yellow and STOP signals. Successive yield light / tricolor light cycles may then be programmed for different times of the day. The yield light controller must also manage the triggering of the pedestrian signals, just the way a traffic light controller would do it.

Various modifications of the above implementations are of course possible by a person skilled in the art without leaving the scope of the invention.

1/ Method of road traffic control involving a permanent signaling system installed at a crossroads or at a simple pedestrian crossing, place thereafter named intersection, the said signaling system comprising a programmable controller and a set of luminous signals belonging to the highway code and triggered by said controller according to a temporal sequence of states granting motorists an alternating right of way, said signals being above or beside the roadways near the intersection, method characterized in that it allows motorists from at least one of the converging ways to pass the said intersection if the other competing lanes are vehicle-free, by display of a luminous STOP (3, 3′, 3″) or Yield (5, 5′, 5″) signal, aimed at those motorists, within the sequence of signals triggered by said controller.

2/ Method of road traffic control according to claim 1, characterized in that a transition state between the ‘off’ and ‘on’ states of the STOP (3, 3′, 3″) or Yield (5, 5′, 5″) signal is triggered by said controller by means of flashing said signal, bringing said sequence to at least three states following the cycle:
State 1: STOP or Yield signal ‘off’,
State 2: STOP or Yield signal flashing,
State 3: STOP or Yield signal ‘on’.

3/ Method of road traffic control according to claim 1, characterized in that the switching off of the STOP or Yield signal is synchronized by said controller with the switching on of a green or flashing yellow traffic light, located on the panel holder of said signal, or on said panel, pointing its luminous beam in the same direction as said signal, and signifying the right of way to motorists, bringing said sequence to at least two states following the cycle:
State 1: green light (1, 1′) or flashing yellow light (2″),
State 2: STOP (3, 3′, 3″) or Yield (5, 5′, 5″) signal.

4/ Method of road traffic control according to claim 3, characterized in that a temporary signal, synchronized with the switching off of said green (1, 1′) or flashing yellow light, preceding the onset of said STOP (3, 3′, 3″) or Yield (5, 5′, 5″) signal, is triggered by said controller by means of a yellow traffic light, located on the panel holder of said signal, or on said panel, pointing its luminous beam in the same direction as said signal, bringing said sequence to at least three states following the cycle:
State 1: green light (1, 1′) or flashing yellow light (2″),
State 2: yellow light (2, 2′),
State 3: STOP (3, 3′, 3″) or Yield (5, 5′, 5″) signal.

5/ Method of road traffic control according to claim 4, characterized in that an additional signal, synchronized with the switching off of said yellow (2, 2′), preceding the onset of said STOP (3, 3′, 3″) or Yield (5, 5′, 5″) signal, is triggered by said controller by means of a red traffic light, located on the panel holder of said signal, or on said panel, pointing its luminous beam in the same direction as said signal, signifying unconditional STOP to motorists, bringing said sequence to at least four states following the cycle:
State 1: green light (1, 1′) or flashing yellow light (2″),
State 2: yellow light (2, 2′),
State 3: red light (4, 4′),
State 4: STOP (3, 3′, 3″) or Yield (5, 5′, 5″) signal.

6/ Method of road traffic control according to claim 5, characterized in that an additional signal, warning motorists of an upcoming green (1, 1′) or flashing yellow light, is triggered by said controller by means of a yellow light (2, 2′) during the STOP (3, 3′, 3″) or Yield (5, 5′, 5″) signal, bringing said sequence to at least five states following the cycle:
State 1: green light (1, 1′) or flashing yellow light (2″),
State 2: yellow light (2, 2′),
State 3: red light (4, 4′),
State 4: STOP (3, 3′, 3″) or Yield (5, 5′, 5″) signal,
State 5: STOP (3, 3′, 3″) or Yield (5, 5′, 5″) signal accompanied by a yellow light (2, 2′).

7/ Method of road traffic control according to claim 6, in the case where state 1 is a green light (1, 1′), characterized in that an additional signal, warning motorists of an upcoming yellow light (2, 2′), is triggered by said controller by means of flashing said green light, bringing said sequence to at least six states following the cycle:
State 1: green light (1, 1′),
State 2: flashing green light,
State 3: yellow light (2, 2′),
State 4: red light (4, 4′),
State 5: STOP (3, 3′, 3″) or Yield (5, 5′, 5″) signal,
State 6: STOP (3, 3′, 3″) or Yield (5, 5′, 5″) signal accompanied by a yellow light (2, 2′).

8/ Method of road traffic control according to any of the preceding claims, characterized in that said STOP (3, 3′, 3″) or Yield (5, 5′, 5″) signal remains ‘on’ as long as signals of the same type located on competing roadways are ‘off’, as long as traffic lights of competing roadways are green or yellow, or as long as pedestrian lights of the roadway where said signal stands indicate the right of way to pedestrians.

9/ Method of road traffic control according to any of the preceding claims, characterized in that the ‘off’ state of said STOP (3, 3′, 3″) or Yield (5, 5′, 5″) signal, as long as it is not synchronized with the display of said red light (4, 4′) (in the case where this one exists), is accompanied by the display of dynamic STOP/Yield signals, or of red lights, to motorists on competing lanes.

10/ Method of road traffic control according to any of the preceding claims, characterized in that the ‘off’ state of said STOP (3, 3′, 3″) or Yield (5, 5′, 5″) signal, as long as it is not synchronized with the display of said red light (4, 4′) (in the case where this one exists), is accompanied, at the pedestrian crossing on the roadway where said signal stands, by a luminous typically red symbol, also triggered by said controller, signifying not to cross the roadway to pedestrians.

11/ Device implementing the procedures of road traffic control according to any of the preceding claims, characterized in that the said programmable controller is a traffic light controller.

12/ Device implementing the procedures of claims 1 to 10, characterized in that said STOP (3, 3′, 3″) or Yield (5, 5′, 5″) signal is integrated in a waterproof casing or panel, and is generated by an incandescent light source backlighting a translucent window on which is displayed a symbol associated with said signal in the highway code.

13/ Device implementing the procedures of claims 1 to 10, whereby said STOP (3, 3′, 3″) or Yield (5, 5′, 5″) signal is integrated on a board with a waterproof casing, reproducing the symbol of said signal in the highway code, characterized in that said board embeds Light-Emitting Diodes (LED) (6) that are visible from motorists, and whose switching on and off is triggered by said controller according to the programmed signal sequence.

14/ Implementation device according to claim 13, characterized in that said STOP (3, 3′, 3″) or Yield (5, 5′, 5″) signal specified in the highway code is entirely generated by a LED (6) matrix whose switching on and off is triggered by said programmable controller.

15/ Implementation device according to claims 12 to 14 in the case where traffic lights are combined with said luminous STOP (3, 3′, 3″) or Yield (5, 5′, 5″) signal, characterized in that the panel of said signal is physically separated from said traffic lights though it is aligned with them in a column or row mechanically fastened, said panel then being placed at either end of that set, which is itself suspended on a bracket or cable above the associated roadway, or is supported by a post on the side of that roadway.

16/ Implementation device according to claim 13 or 14, in the case where traffic lights are combined with the STOP (3, 3′, 3″) or Yield (5, 5′, 5″) dynamic sign board, characterized in that at least one of the said traffic lights is composed of LEDs embedded in the plane of said sign board.

17/ Implementation device according to claim 16, in the case where several traffic lights are embedded within the said STOP (3, 3′, 3″) or Yield (5, 5′, 5″) sign, characterized in that at least two of the said traffic lights partially or totally overlap, and in that, depending on their location on the surface of the sign board, the said light LEDs are single-colored with two states (on or off), two-colored with 3 states, three-colored with 4 states, or even four-colored with 4 states if the three light overlap is total.

18/ Device according to claims 12 to 14, characterized in that it combines a luminous directional arrow, synchronized with said STOP (3, 3′, 3″) or Yield (5, 5′, 5″) signal, on the panel holder of said signal, or on said panel, and contrasting with said signal in that latter case.

19/ Device according to claim 18, in the case where traffic lights are combined with said arrow-equipped signal, characterized in that said traffic lights are luminous directional green, yellow or red arrows, pointing in the same direction as said signal arrow, and switching on in turn upon the traffic light controller command during the multiple-state sequence of said device.
